(19) United States
(12) Patent Application Publication
(10) Pub. No.: US 2025/0212097 A1
(43) Pub. Date: Jun. 26, 2025

(54) CELL SEARCH

(71) Applicant: Nokia Technologies Oy, Espoo (FI)

(72) Inventors: Karri Markus RANTA-AHO, Espoo (FI); Antti Anton TOSKALA, Espoo (FI)

(21) Appl. No.: 18/846,834

(22) PCT Filed: Mar. 15, 2022
(86) PCT No.: PCT/EP2022/056686

§ 371 Date: Sep. 13, 2024

(51) Int. Cl. H04W 48/16; H04W 48/18

(52) U.S. Cl. CPC H04W 48/16; H04W 48/18

(57) ABSTRACT

Disclosed is a method comprising determining a priority communication system among a plurality of communication systems providing communication service in a geographical area; carrying out a first cell search by monitoring for a first synchronization signal shared by the plurality of communication systems; in response to detecting the first synchronization signal, monitoring for an indication for determining a type of a first radio cell found in the first cell search; and in the case the type of the first radio cell corresponds to the priority communication system, carrying out an access procedure to the first radio cell.

### FIELD

The following example embodiments relate to wireless communication.

### BACKGROUND

As new radio access technologies are emerging, there is a challenge in how to operate the new radio access technologies in parallel with existing radio access technologies.

### BRIEF DESCRIPTION

The scope of protection sought for various example embodiments is set out by the independent claims. The example embodiments and features, if any, described in this specification that do not fall under the scope of the independent claims are to be interpreted as examples useful for understanding various embodiments.

According to an aspect, there is provided an apparatus comprising at least one processor, and at least one memory including computer program code, wherein the at least one memory and the computer program code are configured, with the at least one processor, to cause the apparatus to: determine a priority communication system among a plurality of communication systems providing communication service in a geographical area; carry out a first cell search by monitoring for a first synchronization signal shared by the plurality of communication systems; in response to detecting the first synchronization signal, monitor for an indication for determining a type of a first radio cell found in the first cell search; and in the case the type of the first radio cell corresponds to the priority communication system, carry out an access procedure to the first radio cell.

According to another aspect, there is provided an apparatus comprising means for: determining a priority communication system among a plurality of communication systems providing communication service in a geographical area; carrying out a first cell search by monitoring for a first synchronization signal shared by the plurality of communication systems; in response to detecting the first synchronization signal, monitoring for an indication for determining a type of a first radio cell found in the first cell search; and in the case the type of the first radio cell corresponds to the priority communication system, carrying out an access procedure to the first radio cell.

According to another aspect, there is provided a method comprising: determining a priority communication system among a plurality of communication systems providing communication service in a geographical area; carrying out a first cell search by monitoring for a first synchronization signal shared by the plurality of communication systems; in response to detecting the first synchronization signal, monitoring for an indication for determining a type of a first radio cell found in the first cell search; and in the case the type of the first radio cell corresponds to the priority communication system, carrying out an access procedure to the first radio cell.

According to another aspect, there is provided a computer program comprising instructions which, when executed by an apparatus, cause the apparatus to perform at least the following: determining a priority communication system among a plurality of communication systems providing communication service in a geographical area; carrying out a first cell search by monitoring for a first synchronization signal shared by the plurality of communication systems; in response to detecting the first synchronization signal, monitoring for an indication for determining a type of a first radio cell found in the first cell search; and in the case the type of the first radio cell corresponds to the priority communication system, carrying out an access procedure to the first radio cell.

According to another aspect, there is provided a computer program comprising instructions for causing an apparatus to perform at least the following: determining a priority communication system among a plurality of communication systems providing communication service in a geographical area; carrying out a first cell search by monitoring for a first synchronization signal shared by the plurality of communication systems; in response to detecting the first synchronization signal, monitoring for an indication for determining a type of a first radio cell found in the first cell search; and in the case the type of the first radio cell corresponds to the priority communication system, carrying out an access procedure to the first radio cell.

According to another aspect, there is provided a computer readable medium comprising program instructions for causing an apparatus to perform at least the following: determining a priority communication system among a plurality of communication systems providing communication service in a geographical area; carrying out a first cell search by monitoring for a first synchronization signal shared by the plurality of communication systems; in response to detecting the first synchronization signal, monitoring for an indication for determining a type of a first radio cell found in the first cell search; and in the case the type of the first radio cell corresponds to the priority communication system, carrying out an access procedure to the first radio cell.

According to another aspect, there is provided a non-transitory computer readable medium comprising program instructions for causing an apparatus to perform at least the following: determining a priority communication system among a plurality of communication systems providing communication service in a geographical area; carrying out a first cell search by monitoring for a first synchronization signal shared by the plurality of communication systems; in response to detecting the first synchronization signal, monitoring for an indication for determining a type of a first radio cell found in the first cell search; and in the case the type of the first radio cell corresponds to the priority communication system, carrying out an access procedure to the first radio cell.

### LIST OF DRAWINGS

In the following, various example embodiments will be described in greater detail with reference to the accompanying drawings, in which

FIG. 1 illustrates an example embodiment of a cellular communication network;

FIG. 2 illustrates a flow chart;

FIG. 3 illustrates a flow chart;

FIG. 4 illustrates a flow chart;

FIG. 5 illustrates a flow chart;

FIG. 6 illustrates a flow chart;

FIG. 7 illustrates a signaling diagram;

FIG. 8 illustrates an example of a synchronization signal block;

FIG. 9 illustrates an example of a synchronization signal block;

FIG. 10 illustrates an example of a synchronization signal block; and

FIG. 11 illustrates an example embodiment of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different example embodiments will be described using, as an example of an access architecture to which the example embodiments may be applied, a radio access architecture based on long term evolution advanced (LTE Advanced, LTE-A), new radio (NR, 5G), beyond 5G, or sixth generation (6G) without restricting the example embodiments to such an architecture, however. It is obvious for a person skilled in the art that the example embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

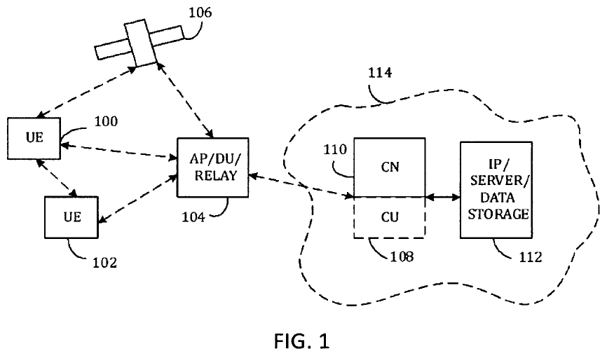

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The example embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node 104, such as an evolved Node B (abbreviated as eNB or eNodeB) or a next generation Node B (abbreviated as gNB or gNodeB), providing the cell. The physical link from a user device to an access node may be called uplink or reverse link, and the physical link from the access node to the user device may be called downlink or forward link. It should be appreciated that access nodes or their functionalities may be implemented by using any node, host, server or access point etc. entity suitable for such a usage.

A communication system may comprise more than one access node, in which case the access nodes may also be configured to communicate with one another over links, wired or wireless, designed for the purpose. These links may be used for signaling purposes. The access node may be a computing device configured to control the radio resources of communication system it is coupled to. The access node may also be referred to as a base station, an access point or any other type of interfacing device including a relay station capable of operating in a wireless environment. The access node may include or be coupled to transceivers. From the transceivers of the access node, a connection may be provided to an antenna unit that establishes bi-directional radio links to user devices. The antenna unit may comprise a plurality of antennas or antenna elements. The access node may further be connected to core network 110 (CN or next generation core NGC). Depending on the system, the counterpart on the CN side may be a serving gateway (S-GW, routing and forwarding user data packets), packet data network gateway (P-GW) for providing connectivity of user devices to external packet data networks, user plane function (UPF), mobility management entity (MME), access and mobility management function (AMF), or location management function (LMF), etc.

The user device illustrates one type of an apparatus to which resources on the air interface may be allocated and assigned, and thus any feature described herein with a user device may be implemented with a corresponding apparatus, such as a relay node. The user device may also be called a subscriber unit, mobile station, remote terminal, access terminal, user terminal, terminal device, or user equipment (UE) just to mention but a few names or apparatuses.

An example of such a relay node may be a layer 3 relay (self-backhauling relay) towards the access node. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and user device(s), and/or between the IAB node and other IAB nodes (multi-hop scenario).

Another example of such a relay node may be a layer 1 relay called a repeater. The repeater may amplify a signal received from an access node and forward it to a user device, and/or amplify a signal received from the user device and forward it to the access node.

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud. The user device (or in some example embodiments a layer 3 relay node) may be configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.)

embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may be expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave-mmWave). One of the concepts considered to be used in 5G networks may be network slicing in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or a base station comprising radio parts. It may also be possible that node operations will be distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and base station operations may differ from that of the LTE or even be non-existent. Some other technology advancements that may be used include big data and all-IP, which may change the way networks are being constructed and managed. 5G (or new radio, NR) networks may be designed to support multiple hierarchies, where MEC servers may be placed between the core and the base station or access node. It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). At least one satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of access nodes, the user device may have an access to a plurality of radio cells and the system may also comprise other apparatuses, such as physical layer relay nodes or other network elements, etc. At least one of the access nodes may be a Home eNodeB or a Home gNodeB. Furthermore, the access node may also be split into: a radio unit (RU) comprising a radio transceiver (TRX), i.e., a transmitter (Tx) and a receiver (Rx); one or more distributed units (DUs) that may be used for the so-called Layer 1 (L1) processing and real-time Layer 2 (L2) processing; and a central unit (CU) (also known as a centralized unit) that may be used for non-real-time 1.2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the access node. The DU may be defined as a logical node hosting radio link control (RLC), medium access control (MAC) and/or physical (PHY) layers of the access node. The operation of the DU may be at least partly controlled by the CU. The CU may comprise a control plane (CU-CP), which may be defined as a logical node hosting the RRC and the control plane part of the PDCP protocol of the CU for the access node. The CU may further comprise a user plane (CU-UP), which may be defined as a logical node hosting the user plane part of the PDCP protocol and the SDAP protocol of the CU for the access node.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned base station units, or different core network operations and base station operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto-or picocells. The access node(s) of FIG. 1 may provide any kind of these cells. A cellular radio system may be implemented as a multilayer network including several kinds of cells. In multilayer networks, one access node may provide one kind of a cell or cells, and thus a plurality of access nodes may be needed to provide such a network structure.

For fulfilling the need for improving the deployment and performance of communication systems, the concept of “plug-and-play” access nodes may be introduced. A network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's network, may aggregate traffic from a large number of Home eNodeBs or Home gNodeBs back to a core network.

With 5G deployments, the dynamic spectrum sharing (DSS) of a 5G NR carrier and a 4G LTE carrier has become a common-place rollout deployment, where the 5G carrier can be deployed on top of an LTE carrier, allowing to support the LTE traffic while providing 5G coverage, even if the traffic demand for 5G is not yet there. In other words, DSS enables 5G and LTE to share the same carrier. Herein the term “carrier” may refer to a carrier wave or carrier signal.

5G transmissions may avoid the LTE physical downlink control channel (PDCCH) and physical downlink shared channel (PDSCH) through time/frequency multiplexing. Furthermore, 5G transmissions may avoid the LTE cell-specific reference signal (CRS) by making holes on the 5G PDSCH resource elements that overlap with the LTE CRS in time and frequency.

The 5G system may need to avoid the LTE CRS, even if there is no active LTE traffic in the LTE cell. This may incur unnecessary capacity loss on the 5G system, which does not depend on the load of the LTE cell. A mechanism called LTE CRS rate-matching has been defined for this purpose for 5G PDSCH transmission. On the other hand, the LTE system may be configured to comprise multicast-broadcast single frequency network (MBSFN) subframes that do not carry the LTE CRS spread over the duration of the MBSFN subframe. The 5G system may use these subframes for synchronization signal block (SSB) transmissions, which may incur capacity loss on the LTE system, even if there is no 5G traffic.

Further down the road, DSS may be used as a sunset technology allowing to keep a low-band (best coverage) LTE carrier to provide the same LTE coverage as before, even with very little LTE traffic, while allowing that carrier to also provide the NR coverage and capacity.

6G is currently being developed, and similar spectrum sharing needs may be expected to arise, when it is time to deploy 6G systems. 5G may be friendlier to spectrum sharing than I.TE (or earlier systems), since 5G does not have any continuously transmitted always-on transmissions like LTE's CRS. The DSS between 5G and LTE suffers from some non-idealities, mostly due to the LTE's always-on CRS signal. On the other hand, in NR, the periodically transmitted SSB may be the only always-on signal. Thus, spectrum sharing between 5G and 6G may be expected to be more practical, as operating these two systems on the same carrier may incur just a marginal overhead, when compared to LTE and 5G sharing the same carrier. For example, on the narrow low-band carriers, the SSB may still lead to unnecessary overhead.

To enable a UE to find a radio cell when entering a communication system, as well as to find new radio cells when moving within the communication system, the UE may use synchronization signals and the physical broadcast channel (PBCH) to derive the information needed to access the target cell. In 5G, the synchronization signals may comprise a primary synchronization signal (PSS) and a secondary synchronization signal (SSS), which may be periodically transmitted on the downlink from the target cell along with the PBCH. Once the UE successfully detects the PSS and/or SSS, it obtains knowledge about the synchronization and physical cell identity (PCI) of the target cell, and the UE is then ready to decode the PBCH. The PBCH carries information needed for further system access, for example to acquire the system information block type 1 (SIB1) of the target cell. The PSS and SSS along with the PBCH can be jointly referred to as a synchronization signal block (SSB). In other words, in 5G, the SSB may comprise a PSS, SSS, and PBCH. The SSB may also be referred to as a synchronization and PBCH block or as an SS/PBCH block. Aiming to cover the whole cell space, the radio cell may transmit multiple SSBs in different directions (beams) in a so-called SSB burst.

However, the cell search may suffer from latency and battery consumption, if a multi-mode UE needs to scan the same frequency bands for multiple different communication systems (radio access systems). The multi-mode UE refers to a UE capable of operating in multiple different communication systems, such as 5G and 6G.

A 6G communication system may provide two different mechanisms to synchronize to a carrier: a first mechanism designed for DSS between 5G and 6G, and a second mechanism for 6G standalone. The DSS between 5G and 6G may also be referred to as 5G/6G DSS herein.

The first mechanism, i.e., the DSS-supporting synchronization mechanism, may use the 5G-defined PSS and SSS also for 6G cells. In case of a deployment with DSS between 5G and 6G, the PSS/SSS pair may be used to detect both the 5G and 6G carrier. A 6G cell may additionally transmit a 6G-specific signal that may be used (after PSS and SSS detection) to differentiate if there is also a 6G cell present on the carrier.

In the second mechanism, i.e., the 6G standalone synchronization mechanism, the 6G SSB structure may comprise the same PSS as defined for 5G, but there is no 5G-specified SSS in the same time and frequency domain location relative to the PSS. This prevents 5G UEs from detecting the carrier, when there is no 5G cell present. The 6G SSB may comprise a 6G-specific SSS sequence in place of the 5G SSS, and the 6G-specific SSS may be in the same or a different location in time and/or frequency domain (relative to the PSS) as the 5G SSS. Alternatively, the 6G SSB may comprise the 5G SSS sequence, but with a different location in time and/or frequency domain (relative to the PSS) compared to the 5G SSB.

Thus, a UE supporting both 5G and 6G may search for just one type of PSS on the frequency bands designated for both systems to find a carrier and its timing. After finding the PSS that is common to 5G and 6G and constructed according to the 5G specification, the UE may proceed to differentiate whether the radio cell it found is a 5G cell or a 6G cell. If the UE finds the 5G SSS, it may do an additional check (after PSS and SSS detection) to determine if the 6G cell is present, or if it found a carrier with just a 5G cell. In comparison, with LTE and 5G cells, the UE would first have to search for example for 5G PSS, and if not found, try again with LTE PSS, thus increasing the search time and battery consumption.

For 6G standalone, the presence of the additional check (after PSS and SSS detection) in the DSS synchronization may not be necessary, as the radio cell may be uniquely identified as a 6G cell from the SSS. However, the additional check at least in the form of PBCH may be present. This PSS/SSS pair may not cause a 5G UE to detect the 6G cell.

On the UE side, the cell search may be performed so that, with a single PSS search procedure, the UE can sweep the frequencies and bands that may be used to deploy 5G, 6G, or both, rather than having to separately search for 5G and 6G. Further, after finding that there is a 5G cell present (e.g., PSS indicating that there is something on the carrier, and SSS indicating that there is 5G on the carrier), the UE cell searcher may further check if the carrier is a DSS carrier and if there is also a 6G cell present on the carrier.

This procedure may be facilitated by organizing the different synchronization sequences to differentiate between 5G-only, 6G-only and 5G/6G DSS deployment on a carrier, so that a 5G UE is able to find the 5G cell if it is there, and not get confused with a 6G-only carrier.

Some examples described below may enable an apparatus such as a UE to monitor (search) for just one type of PSS that is common to multiple different communication systems. Thus, latency and/or power consumption may be reduced in the cell search procedure.

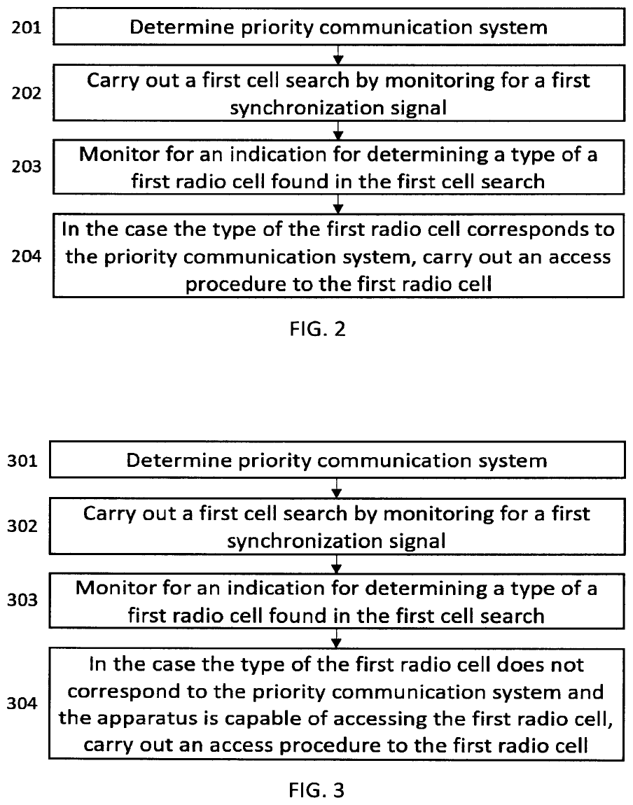

FIG. 2 illustrates a flow chart according to an example of a method performed by an apparatus such as, or comprised in, a user device. The user device may also be called a subscriber unit, mobile station, remote terminal, access terminal, user terminal, terminal device, or user equipment (UE). The user device may correspond to any of the user devices 100, 102 of FIG. 1.

Referring to FIG. 2, in block 201, a priority communication system among a plurality of communication systems providing communication service in a geographical area is determined. Determining the priority communication system may mean determining, or selecting, a radio access technology to be prioritized among a plurality of different radio access technologies. The plurality of communication systems may deploy spectrum sharing.

The priority communication system may be determined based on one or more pre-defined criteria. The one or more pre-defined criteria may comprise, for example, at least one of: one or more communication systems supported by the apparatus, a type of the apparatus, and/or a service type. The type of the apparatus may comprise, for example, at least one of: a reduced capability (RedCap) device, a non-RedCap device, a vehicle-mounted device, and/or a fixed wireless device.

In block 202, a first cell search is carried out, or initiated, by monitoring for a first synchronization signal shared by the plurality of communication systems. The first synchronization signal being shared by the plurality of communication systems means that the first synchronization signal is common to the plurality of communications. For example, the first synchronization signal may be a primary synchronization signal common to the plurality of communication systems.

In block 203, in response to detecting the first synchronization signal, the apparatus monitors, or searches, for an indication for determining a type of a first radio cell found in the first cell search. The indication may be comprised in the same SSB as the first synchronization signal. The first radio cell may be found by detecting the first synchronization signal.

For example, the indication may be for at least one frequency position of a synchronization block for system acquisition, the indication being informed by a secondary synchronization signal common for the plurality of communication systems. In other words, the indication may be a secondary synchronization signal at least for some synchronization frequencies, and the secondary synchronization signal may be common to the plurality of communication systems.

As another example, the indication may be a secondary synchronization signal specific to the priority communication system. The secondary synchronization signal specific to the priority communication system may be specific by a distinctive time and/or frequency domain location. Alternatively, or additionally, the secondary synchronization signal specific to the priority communication system may be specific by a distinctive sequence.

As another example, the indication may be a tertiary synchronization signal specific to the priority communication system.

In block 204, in the case the type of the first radio cell corresponds to the priority communication system based on the determination, an access procedure to the first radio cell is carried out, or initiated.

FIG. 3 illustrates a flow chart according to an example of a method performed by an apparatus such as, or comprised in, a user device. The example illustrated in FIG. 3 may be based on the example illustrated in FIG. 2. The user device may also be called a subscriber unit, mobile station, remote terminal, access terminal, user terminal, terminal device, or user equipment (UE). The user device may correspond to any of the user devices 100, 102 of FIG. 1.

Referring to FIG. 3, in block 301, a priority communication system among a plurality of communication systems providing communication service in a geographical area is determined.

In block 302, a first cell search is carried out, or initiated, by monitoring for a first synchronization signal shared by the plurality of communication systems. For example, the first synchronization signal may be a primary synchronization signal common to the plurality of communication systems.

In block 303, in response to detecting the first synchronization signal, the apparatus monitors for an indication for determining a type of a first radio cell found in the first cell search.

For example, the indication may be for at least one frequency position of a synchronization block for system acquisition, the indication being informed by a secondary synchronization signal common for the plurality of communication systems. In other words, the indication may be a secondary synchronization signal at least for some synchronization frequencies, and the secondary synchronization signal may be common to the plurality of communication systems.

As another example, the indication may be a secondary synchronization signal specific to another communication system of the plurality of communication systems. The secondary synchronization signal specific to the other communication system may be specific by a distinctive time and/or frequency domain location. Alternatively, or additionally, the secondary synchronization signal specific to the other communication system may be specific by a distinctive sequence.

As another example, the indication may be a tertiary synchronization signal specific to the other communication system.

In block 304, in the case the type of the first radio cell does not correspond to the priority communication system and the apparatus is capable of accessing the first radio cell, an access procedure to the first radio cell is carried out, or initiated. In other words, in this case, the first radio cell may correspond to the other communication system of the plurality of communication systems.

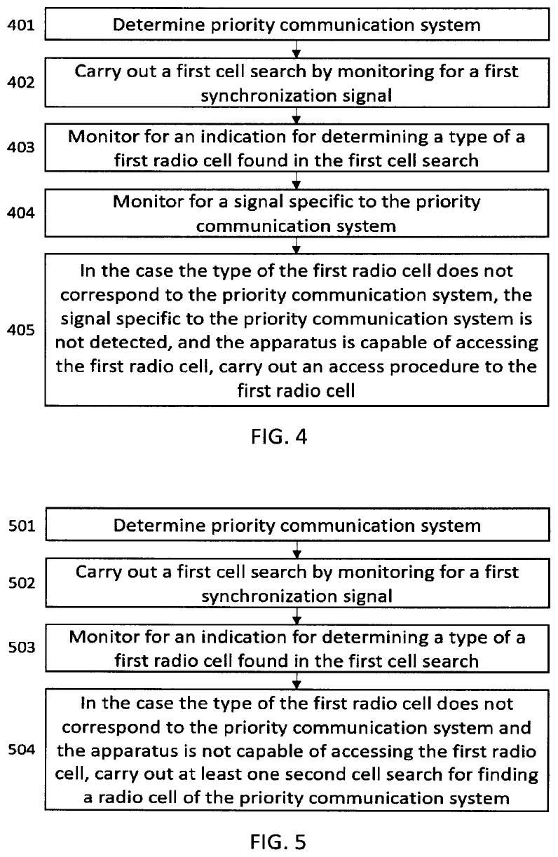

FIG. 4 illustrates a flow chart according to an example of a method performed by an apparatus such as, or comprised in, a user device. The example illustrated in FIG. 4 may be based on the example illustrated in FIG. 2. The user device may also be called a subscriber unit, mobile station, remote terminal, access terminal, user terminal, terminal device, or user equipment (UE). The user device may correspond to any of the user devices 100, 102 of FIG. 1.

Referring to FIG. 4, in block 401, a priority communication system among a plurality of communication systems providing communication service in a geographical area is determined.

In block 402, a first cell search is carried out, or initiated, by monitoring for a first synchronization signal shared by the plurality of communication systems. For example, the first synchronization signal may be a primary synchronization signal common to the plurality of communication systems.

In block 403, in response to detecting the first synchronization signal, the apparatus monitors for an indication for determining a type of a first radio cell found in the first cell search.

For example, the indication may be for at least one frequency position of a synchronization block for system acquisition, the indication being informed by a secondary synchronization signal common for the plurality of communication systems. In other words, the indication may be a secondary synchronization signal at least for some synchronization frequencies, and the secondary synchronization signal may be common to the plurality of communication systems.

As another example, the indication may be a secondary synchronization signal specific to another communication system of the plurality of communication systems. The secondary synchronization signal specific to the other communication system may be specific by a distinctive time and/or frequency domain location. Alternatively, or additionally, the secondary synchronization signal specific to the other communication system may be specific by a distinctive sequence.

As another example, the indication may be a tertiary synchronization signal specific to the other communication system.

In block 404, in the case the type of the first radio cell does not correspond to the priority communication system, the apparatus monitors, or searches, for a signal specific to the priority communication system.

As an example, the signal specific to the priority communication system may be a secondary synchronization signal specific to the priority communication system. The secondary synchronization signal specific to the priority communication system may be specific by a distinctive time and/or frequency domain location. Alternatively, or additionally, the secondary synchronization signal specific to the priority communication system may be specific by a distinctive sequence.

As another example, the signal specific to the priority communication system may be a tertiary synchronization signal specific to the priority communication system.

In block 405, in the case the type of the first radio cell does not correspond to the priority communication system, the signal specific to the priority communication system is not detected, and the apparatus is capable of accessing the first radio cell, an access procedure to the first radio cell is carried out, or initiated. In other words, prior to the access procedure to the first radio cell of the other communication system, the apparatus monitors for the signal specific to the priority communication system in order to try to find a radio cell of the priority communication system.

FIG. 5 illustrates a flow chart according to an example of a method performed by an apparatus such as, or comprised in, a user device. The example illustrated in FIG. 5 may be based on the example illustrated in FIG. 2. The user device may also be called a subscriber unit, mobile station, remote terminal, access terminal, user terminal, terminal device, or user equipment (UE). The user device may correspond to any of the user devices 100, 102 of FIG. 1.

Referring to FIG. 5, in block 501, a priority communication system among a plurality of communication systems providing communication service in a geographical area is determined.

In block 502, a first cell search is carried out, or initiated, by monitoring for a first synchronization signal shared by the plurality of communication systems. For example, the first synchronization signal may be a primary synchronization signal common to the plurality of communication systems.

In block 503, in response to detecting the first synchronization signal, the apparatus monitors for an indication for determining a type of a first radio cell found in the first cell search.

For example, the indication may be for at least one frequency position of a synchronization block for system acquisition, the indication being informed by a secondary synchronization signal common for the plurality of communication systems. In other words, the indication may be a secondary synchronization signal at least for some synchronization frequencies, and the secondary synchronization signal may be common to the plurality of communication systems.

As another example, the indication may be a secondary synchronization signal specific to another communication system of the plurality of communication systems. The secondary synchronization signal specific to the other communication system may be specific by a distinctive time and/or frequency domain location. Alternatively, or additionally, the secondary synchronization signal specific to the other communication system may be specific by a distinctive sequence.

As another example, the indication may be a tertiary synchronization signal specific to the other communication system.

In block 504, in the case the type of the first radio cell does not correspond to the priority communication system and the apparatus is not capable of accessing the first radio cell, the apparatus carries out, or initiates, at least one second cell search for finding a radio cell of the priority communication system.

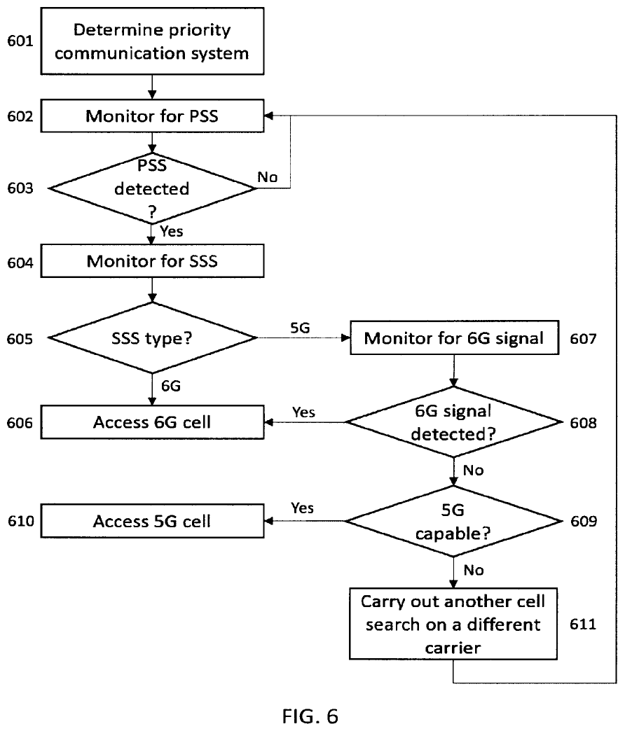

FIG. 6 illustrates a flow chart according to an example of a method performed by an apparatus such as, or comprised in, a user device. The example illustrated in FIG. 6 may be based on the example illustrated in FIG. 2. The user device may also be called a subscriber unit, mobile station, remote terminal, access terminal, user terminal, terminal device, or user equipment (UE). The user device may correspond to any of the user devices 100, 102 of FIG. 1.

FIG. 6 is described using principles and terminology of 5G and 6G technology without limiting the examples to those communication systems, however.

Referring to FIG. 6, in block 601, a priority communication system among a plurality of communication systems providing communication service in a geographical area is determined.

As an example, the plurality of communication systems may comprise at least a 5G communication system and a 6G communication system. However, it should be noted that the plurality of communication systems are not restricted to 5G and 6G. If the apparatus supports one communication system of the plurality of communication systems, then it may determine the supported communication system as the priority communication system. If the apparatus supports both the 5G communication system and the 6G communication system (i.e., if the apparatus is 5G and 6G capable), then the 6G communication system may be determined as the priority communication system.

Alternatively, the 5G communication system may be determined as the priority communication system, if the apparatus supports both 5G and 6G.

Two different synchronization options may be defined at least for frequency bands common to 5G and 6G (and may deploy 5G, 6G, or both 5G and 6G on a DSS carrier). One of the 6G cell synchronization options may use the 5G PSS, SSS and synchronization raster. This allows for 5G/6G DSS using just one PSS and SSS on the carrier that allows both 5G UEs and 6G UEs to detect the carrier and synchronize to it. The synchronization raster indicates the frequency positions of the synchronization block that can be used by the UE for system acquisition. The synchronization raster may be defined for each frequency band, which is a subset of the global synchronization channel number (GSCN).

Another 6G cell synchronization option may use the 5G PSS, but does not include the 5G SSS in the same time and frequency domain location relative to the PSS as in 5G. This allows for deploying a 6G carrier and preventing 5G-only UEs from falsely thinking that there is a 5G cell on this carrier. One possibility is to use the same 5G SSS sequence set in 6G, but that SSS may be differently located in time and/or frequency domain (e.g., mapped differently to one or more subcarriers) in 6G compared to 5G. Another possibility is to use a distinctive sequence different from the 5G SSS sequence, or both a distinctive sequence and a distinctive location in time and/or frequency domain, for a 6G-only deployment. This prevents 5G UEs from thinking that they found a 5G cell, when the radio cell is actually a 6G cell.

In block 602, the apparatus carries out, or initiates, a first cell search by monitoring (searching) for a PSS shared by the plurality of communication systems. In other words, the PSS may be common to the plurality of communication systems. For example, the same 5G PSS may be used by both the 5G communication system and the 6G communication system. Herein the PSS may also be referred to as a first synchronization signal.

In block 603, it is checked whether the PSS is detected. If no PSS is detected (block 603: no), then the process returns to block 602, i.e., the apparatus continues to monitor for the PSS.

In block 604, in response to detecting the PSS (block 603: yes), which indicates that at least a first radio cell has been found in the first cell search, the apparatus monitors for an indication such as an SSS for determining a type of the first radio cell found in the first cell search. The type of the first radio cell may refer to the radio access technology (e.g., 5G or 6G) utilized by the first radio cell. It should be noted that the PSS and the SSS may be comprised in the same SSB.

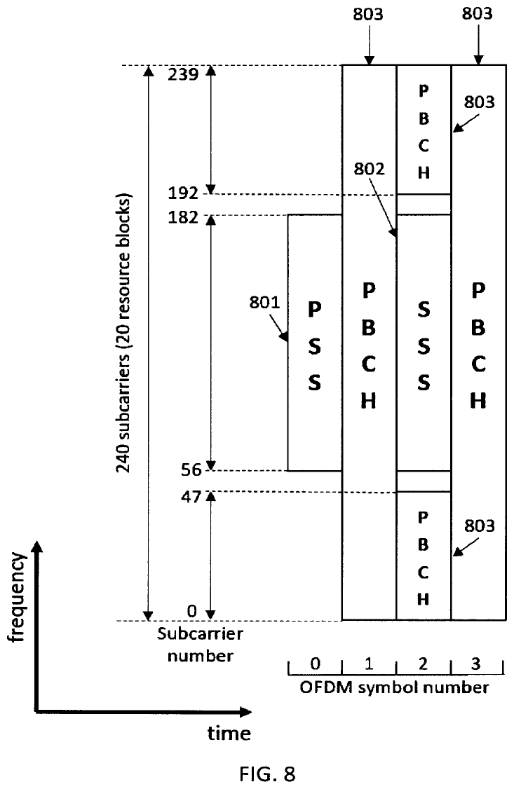

For example, the apparatus may monitor for the SSS with the 5G PBCH assumption relative to the detected PSS. In other words, the apparatus may try to find a 5G SSS at the distinctive time and/or frequency domain location of the 5G SSS relative to the PSS (e.g., according to the SSB structure shown in FIG. 8).

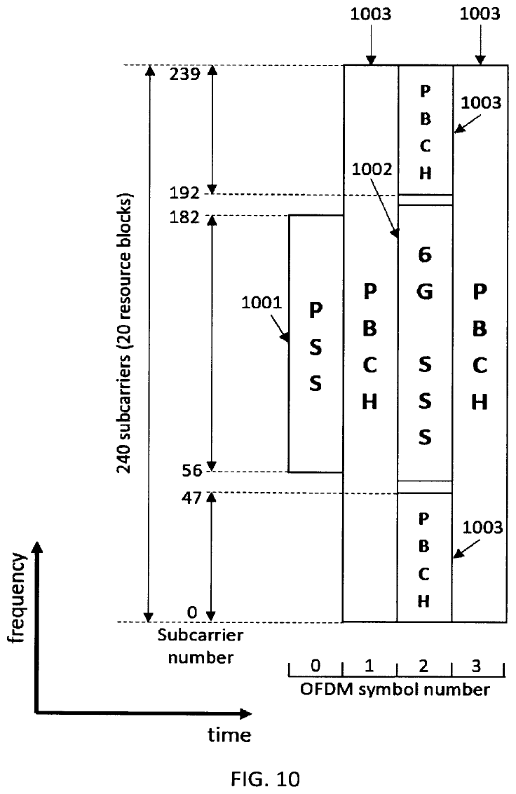

If the 5G SSS is not detected, then the apparatus may monitor for the SSS with the 6G PBCH assumption relative to the detected PSS. In other words, the apparatus may monitor for a 6G-specific SSS at the distinctive time and/or frequency domain location of the 6G-specific SSS relative to the PSS (e.g., according to the SSB structure shown in FIG. 10). Alternatively, or additionally, the apparatus may monitor for a distinctive sequence specific to the 6G-specific SSS.

In block 605, the SSS is detected in response to the monitoring of block 604, and the type of the SSS is used to determine the type of the first radio cell found in the first cell search.

In block 606, in the case the detected SSS is specific to the priority communication system, for example if the SSS is a 6G-specific SSS (block 605: 6G), then it is determined that the type of the first radio cell corresponds to the priority communication system (e.g., the first radio cell may be a 6G cell in this case). In the case the type of the first radio cell corresponds to the priority communication system, the apparatus carries out an access procedure to the first radio cell (e.g., 6G cell). The apparatus may also monitor for another signal, such as TSS and/or PBCH, specific to the priority communication system. Prior to the access procedure, the apparatus may read the PBCH (e.g., 6G PBCH) of the first radio cell.

Alternatively, in block 607, in the case the detected SSS is not specific to the priority communication system, for example if the SSS is a 5G SSS (block 605: 5G), then it is determined that the type of the first radio cell does not correspond to the priority communication system. In the case the type of the first radio cell does not correspond to the priority communication system, the apparatus may monitor for a signal specific to the priority communication system (e.g., a 6G-specific signal). In other words, the detection of the 5G SSS may indicate that at least a 5G cell is present on the carrier, and the apparatus may monitor for the 6G-specific signal in order to determine whether a 6G cell is also present on the carrier. The apparatus may monitor for the signal specific to the priority communication system at a distinctive time and/or frequency domain location of the signal relative to the PSS.

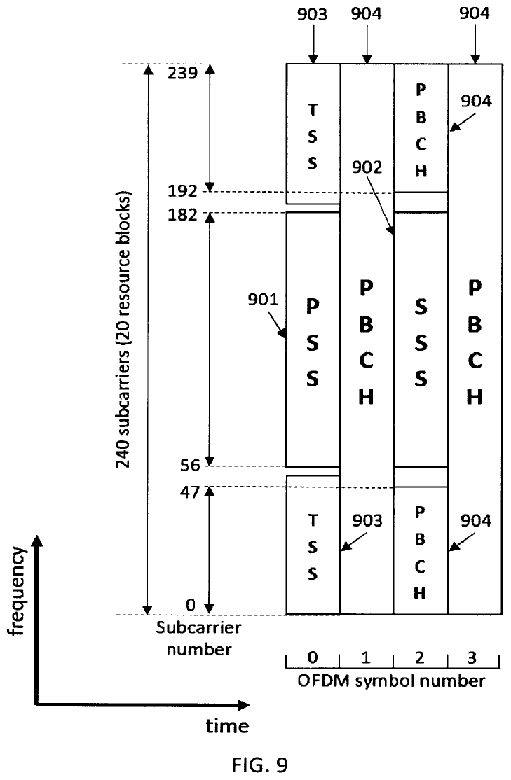

For example, the signal specific to the priority communication system may comprise a TSS specific to the priority communication system (e.g., TSS 903 of FIG. 9). The TSS may be part of the 6G initial access related signals in addition to the PSS and/or SSS.

As another example, the signal specific to the priority communication system may comprise an SSS specific to the priority communication system, for example a 6G-specific SSS that may be present on the carrier.

As another example, the signal specific to the priority communication system may comprise a PBCH specific to the priority communication system, for example a 6G-specific PBCH that the apparatus tries to decode, in case there is no need to increase the number of PCIs from what 5G offers.

In block 608, it is checked whether the signal specific to the priority communication system is detected.

In block 606, in the case the signal specific to the priority communication system is detected (block 608: yes), which indicates that a radio cell of the priority communication system has been found, then the apparatus carries out an access procedure to the radio cell of the priority communication system (e.g., 6G cell). Prior to the access procedure, the apparatus may read the PBCH (e.g., 6G PBCH) of the radio cell of the priority communication system.

Alternatively, in block 609, in the case the signal specific to the priority communication system is not detected (block 608: no), then it is checked whether the apparatus is capable of accessing the first radio cell (e.g., 5G cell in this case). For example, the apparatus may check whether it is 5G-capable.

In block 610, in the case the type of the first radio cell does not correspond to the priority communication system, the signal specific to the priority communication system is not detected, and the apparatus is capable of accessing the first radio cell (block 609: yes), the apparatus carries out an access procedure to the first radio cell (e.g., 5G cell in this case). In other words, in this case, prior to the access procedure to the first radio cell, the apparatus may monitor for the signal specific to the priority communication system, and if the signal specific to the priority communication system is not found, then the apparatus carries out the access procedure to the first radio cell. Prior to the access procedure, the apparatus may read the PBCH (e.g., 5G PBCH) corresponding to the first radio cell.

Alternatively, in block 611, in the case the type of the first radio cell does not correspond to the priority communication system, the signal specific to the priority communication system is not detected, and the apparatus is not capable of accessing the first radio cell (block 609: no), then the apparatus may carry out, or initiate, at least one second cell search for finding a radio cell of the priority communication system. For example, the apparatus may abandon the carrier as a 5G carrier not supported by the apparatus, and continue searching for a 6G cell on a different carrier. Following block 611, the process may return to block 602, wherein the apparatus may monitor for a PSS on the different carrier.

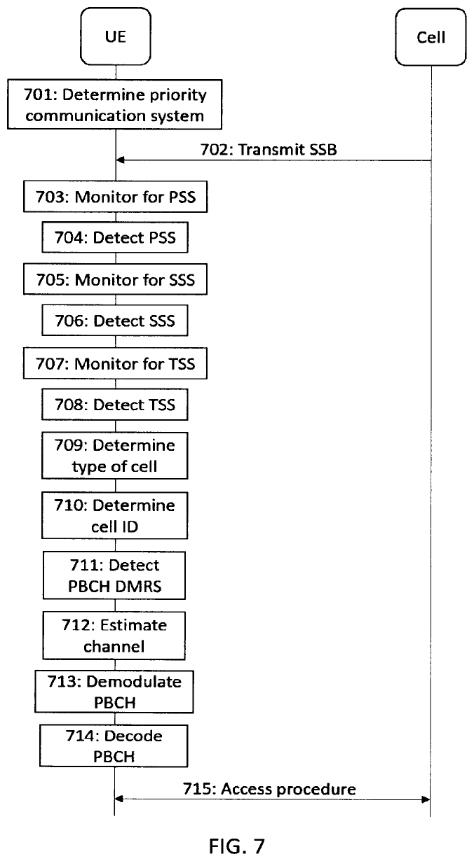

FIG. 7 illustrates a signaling diagram according to an example. The example illustrated in FIG. 7 may be based on the example illustrated in FIG. 2.

Referring to FIG. 7, in block 701, a UE determines a priority communication system among a plurality of communication systems providing communication service in a geographical area. The plurality of communication systems may deploy spectrum sharing. The priority communication system may be determined based on at least one of: one or more supported communication systems and/or a requested service. The UE may correspond to any of the user devices 100, 102 of FIG. 1.

In block 702, a network element transmits, or broadcasts, an SSB. The SSB may be transmitted periodically. The SSB may comprise at least a PSS and a PBCH, as well as an SSS and/or TSS. The PSS may be shared by (common to) the plurality of communication systems. Some examples of the SSB are illustrated in FIGS. 8-10.

The network element may provide at least a radio cell of the priority communication system. The network element may also provide another radio cell on the same carrier as the radio cell of the priority communication system, wherein the other radio cell may correspond to another communication system of the plurality of communication systems. The network element may correspond to the access node 104 of FIG. 1. The network element may also be referred to, for example, as a network node, a RAN node, a base station, a base transceiver station (BTS), a gNB, an access point (AP), a distributed unit (DU), or a transmission and reception point (TRP).

In block 703, the UE carries out a first cell search by monitoring for the PSS. The PSS may also be referred to as a first synchronization signal herein.

In block 704, the UE detects the PSS in response to monitoring for the PSS. The detection of the PSS indicates that at least a first radio cell has been found in the first cell search.

In block 705, the UE may monitor for the SSS in response to detecting the PSS.

In block 706, the UE may detect the SSS in response to monitoring for the SSS.

In block 707, the UE may monitor for the TSS in response to detecting the PSS and/or SSS.

In block 708, the UE may detect the TSS in response to monitoring for the TSS.

In block 709, the UE determines, in response to detecting the SSS and/or TSS, a type of the first radio cell found in the first cell search. In other words, the SSS and/or the TSS may be an indication for determining the type of the first radio cell found in the first cell search. In the case the SSS and/or the TSS is specific to the priority communication system, then the UE may determine that the type of the first radio cell corresponds to the priority communication system.

The SSS may be specific to the priority communication system by a distinctive time and/or frequency domain location of the SSS relative to the PSS, compared to the SSS locations of other communication systems of the plurality of communication systems. Alternatively, or additionally, the SSS may be specific to the priority communication system by a distinctive sequence compared to the SSS sequences of the other communication system of the plurality of communication systems.

In block 710, upon successfully decoding the PSS, SSS and/or TSS, the UE obtains information about the time and frequency synchronization as well as the PCI (i.e., cell identity) of the first radio cell.

In block 711, the UE detects a demodulation reference signal (DMRS) associated with the PBCH for obtaining the SSB index and radio frame timing relative to the detected SSB location in time domain. In other words, the location of the SSB in time domain may be used as an anchor, and after knowing the SSB index, the radio frame boundary relative to that anchor can be calculated.

In block 712, the UE estimates the radio channel between the UE and the first radio cell based on the detected DMRS for demodulation of the PBCH.

In block 713, the UE demodulates the PBCH of the first radio cell.

In block 714, in response to the demodulation, the UE decodes the PBCH of the first radio cell based on the PBCH DMRS. Herein decoding the PBCH may refer to decoding the PBCH data, or PBCH payload. The PBCH may comprise, for example, the master information block (MIB) of the first radio cell. Upon decoding the PBCH, the UE may read the MIB to obtain the system frame number (SFN).

In block 715, based on the information obtained from the PBCH, as well as the information obtained from the PSS, SSS and/or TSS, the UE carries out an access procedure to access the first radio cell, in the case the type of the first radio cell corresponds to the priority communication system. For example, the UE may initiate a random-access procedure, i.e., an initial access procedure, to access the first radio cell. The random-access procedure may be initiated, for example, by transmitting a random-access preamble to the network element.

The blocks described above by means of FIGS. 2-7 are in no absolute chronological order, and some of them may be performed simultaneously or in an order differing from the described one. Other blocks may also be executed between them or within them. Some of the blocks or a part of the blocks may also be left out.

FIG. 8 illustrates an example of a 5G SSB. The 5G SSB comprises a primary synchronization signal (PSS) 801, a secondary synchronization signal (SSS) 702, and a physical broadcast channel (PBCH) 803. In the example of FIG. 8, the PBCH is spread over three orthogonal frequency-division multiplexing (OFDM) symbols (OFDM symbols #1, #2, and #3).

In the example of FIG. 8, the PSS 801 and the SSS 802 both span over 127 subcarriers. On a given subcarrier, the PSS 801 comprises a signal that represents a complex value, and these 127 complex values in order form the PSS sequence. Similarly, on a given subcarrier, the SSS 802 comprises a signal that represents a complex value, and these 127 complex values form the SSS sequence. In 5G, there may be three valid PSS sequences, and the UE may check if it finds one of these three valid PSS sequences to determine if it found a carrier. Furthermore, in 5G, there may be 336 valid SSS sequences, and the UE may check if it finds one of these valid SSS sequences after it found the PSS. Thus, there may be 1008 possible PSS/SSS combinations in 5G, and a given radio cell may transmit one valid PSS/SSS combination.

FIG. 9 illustrates an example of an SSB for 5G/6G DSS. In this example, the SSB comprises a PSS 901, an SSS 902, a tertiary synchronization signal (TSS) 903, and a PBCH 904. It should be noted that the location of the TSS 903 shown in FIG. 9 is just an example, and the location of the TSS 903 may also be different than shown in FIG. 9.

Cell search of a 5G UE and a 6G UE on a carrier that transmits a common PSS 901 shared by 5G and 6G may be implemented for example as follows. For a 5G/6G DSS deployment, the 5G UE may find the 5G cell based on the presence of the PSS 901 and/or SSS 902, and the 5G UE may continue with the 5G system information acquisition by reading the PBCH 904 of the SSB (e.g., the SSB of FIG. 9). The 6G UE may find the same PSS 901 and SSS 902, but at this point in time may not be able to determine whether the radio cell is a 5G cell, a 6G cell, or if both are present on the carrier. The 6G UE may check if a 6G cell is present by searching for a 6G-specific signal, such as the TSS 903, that is distinctive to 6G. In other words, the 6G-specific signal is not present, if a 6G cell is not present on the carrier. If the 6G-specific signal is not found, and the UE is also 5G-capable, the UE may carry out an access procedure to the 5G cell.

FIG. 10 illustrates an example of a 6G standalone SSB. In this example, the SSB comprises a PSS 1001, a 6G-specific SSS 1002, and a PBCH 1003. Due to the presence of the 6G-specific SSS 1002, a 5G UE would not detect the 6G standalone SSB. It should be noted that the locations of the PBCH 1003 and the 6G-specific SSS 1002 shown in FIG. 10 are just an example, and the locations of the PBCH 1003 and the 6G-specific SSS 1002 may also be different than shown in FIG. 10. The 6G standalone SSB may further comprise a TSS (not shown in FIG. 10) and omit the 6G-specific SSS 1002, in which case the TSS may act as a 6G SSS, and the space freed from the 6G-specific SSS 1002 may be used for something else or left blank.

The 6G-specific SSS 1002 may comprise a distinctive sequence different from the 5G SSS sequence. The distinctive sequence means that the 6G SSS sequence has such properties that a 5G SSS detector trying to detect if one of the valid 336 5G SSS sequences are found would not determine that any of the valid 6G SSS sequences looks so much like any of the 5G SSS sequences that a 6G cell would be accidentally detected as a 5G cell by a 5G UE.

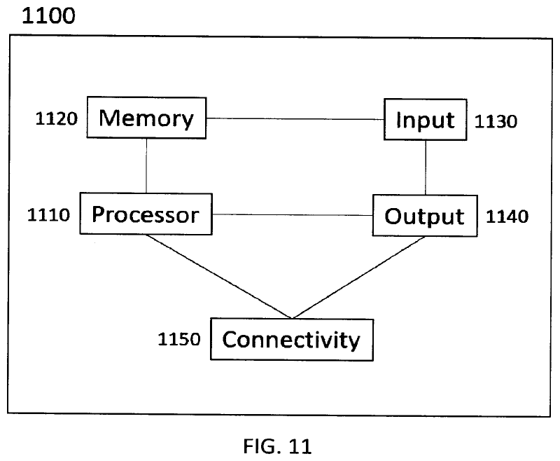

FIG. 11 illustrates an example embodiment of an apparatus 1100, which may be an apparatus such as, or comprised in, a user device. The apparatus 1100 may correspond to any of the user devices 100, 102 of FIG. 1. The user device may also be called a subscriber unit, mobile station, remote terminal, access terminal, user terminal, terminal device, or user equipment (UE).

The apparatus 1100 comprises a processor 1110. The processor 1110 interprets computer program instructions and processes data. The processor 1110 may comprise one or more programmable processors. The processor 1110 may comprise programmable hardware with embedded firmware and may, alternatively or additionally, comprise one or more application-specific integrated circuits (ASICs).

The processor 1110 is coupled to a memory 1120. The processor is configured to read and write data to and from the memory 1120. The memory 1120 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 1120 stores computer readable instructions that are executed by the processor 1110. For example, non-volatile memory stores the computer readable instructions, and the processor 1110 executes the instructions using volatile memory for temporary storage of data and/or instructions.

The computer readable instructions may have been pre-stored to the memory 1120 or, alternatively or additionally, they may be received, by the apparatus, via an electromagnetic carrier signal and/or may be copied from a physical entity such as a computer program product. Execution of the computer readable instructions causes the apparatus 1100 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 1100 may further comprise, or be connected to, an input unit 1130. The input unit 1130 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units.

Further, the input unit 1130 may comprise an interface to which external devices may connect to.

The apparatus 1100 may also comprise an output unit 1140. The output unit may comprise or be connected to one or more displays capable of rendering visual content, such as a light emitting diode (LED) display, a liquid crystal display (LCD) and/or a liquid crystal on silicon (LCoS) display. The output unit 1140 may further comprise one or more audio outputs. The one or more audio outputs may be for example loudspeakers.

The apparatus 1100 further comprises a connectivity unit 1150. The connectivity unit 1150 enables wireless connectivity to one or more external devices. The connectivity unit 1150 comprises at least one transmitter and at least one receiver that may be integrated to the apparatus 1100 or that the apparatus 1100 may be connected to. The at least one transmitter comprises at least one transmission antenna, and the at least one receiver comprises at least one receiving antenna. The connectivity unit 1150 may comprise an integrated circuit or a set of integrated circuits that provide the wireless communication capability for the apparatus 1100. Alternatively, the wireless connectivity may be a hardwired application-specific integrated circuit (ASIC). The connectivity unit 1150 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 1100 may further comprise various components not illustrated in FIG. 11. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory (ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the example embodiments.

1-12. (canceled)

13. An apparatus comprising at least one processor, and at least one memory including computer program code, wherein the at least one memory and the computer program code are configured, with the at least one processor, to cause the apparatus to:
determine a priority communication system among a plurality of communication systems providing communication service in a geographical area;
carry out a first cell search by monitoring for a first synchronization signal shared by the plurality of communication systems;
in response to detecting the first synchronization signal, monitor for an indication for determining a type of a first radio cell found in the first cell search; and
in the case the type of the first radio cell corresponds to the priority communication system, carry out an access procedure to the first radio cell.

14. The apparatus according to claim 13, wherein the indication is for at least one frequency position of a synchronization block for system acquisition, the indication being informed by a secondary synchronization signal common for the plurality of communication systems.

15. The apparatus according to claim 13, wherein the indication is a secondary synchronization signal specific to the priority communication system.

16. The apparatus according to claim 13, wherein the indication is a secondary synchronization signal specific to the priority communication system, and wherein the secondary synchronization signal specific to the priority communication system is specific by a distinctive time and/or frequency domain location.

17. The apparatus according to claim 13, wherein the indication is a secondary synchronization signal specific to the priority communication system, and wherein the secondary synchronization signal specific to the priority communication system is specific by a distinctive sequence.

18. The apparatus according to claim 13, wherein the indication is a tertiary synchronization signal specific to the priority communication system.

19. The apparatus according to claim 13, further comprising being caused to:
in the case the type of the first radio cell does not correspond to the priority communication system and the apparatus is capable of accessing the first radio cell, carry out the access procedure to the first radio cell.

20. The apparatus according to claim 13, further comprising being caused to, in the case the type of the first radio cell does not correspond to the priority communication system and the apparatus is capable of accessing the first radio cell, carry out the access procedure to the first radio cell, and prior to the access procedure to the first radio cell, monitor for a signal specific to the priority communication system.

21. The apparatus according to claim 13, further comprising being caused to:
in the case the type of the first radio cell does not correspond to the priority communication system and the apparatus is not capable of accessing the first radio cell, carry out at least one second cell search for finding a radio cell of the priority communication system.

22. A method comprising:
determining a priority communication system among a plurality of communication systems providing communication service in a geographical area;
carrying out a first cell search by monitoring for a first synchronization signal shared by the plurality of communication systems;
in response to detecting the first synchronization signal, monitoring for an indication for determining a type of a first radio cell found in the first cell search; and
in the case the type of the first radio cell corresponds to the priority communication system, carrying out an access procedure to the first radio cell.

23. A computer program comprising instructions which, when executed by an apparatus, cause the apparatus to perform at least the following:
determining a priority communication system among a plurality of communication systems providing communication service in a geographical area;
carrying out a first cell search by monitoring for a first synchronization signal shared by the plurality of communication systems;
in response to detecting the first synchronization signal, monitoring for an indication for determining a type of a first radio cell found in the first cell search; and
in the case the type of the first radio cell corresponds to the priority communication system, carrying out an access procedure to the first radio cell.
